(19) United States
(12) Patent Application Publication
(10) Pub. No.: US 2015/0317638 A1
(43) Pub. Date: Nov. 5, 2015

(54) Methods, Devices and Systems for Transaction Initiation

(71) Applicant: MASTERCARD INTERNATIONAL INCORPORATED, Purchase, NY (US)

(72) Inventor: Stephanie Donaldson, Peterborough (GB)

(21) Appl. No.: 14/698,290

(22) Filed: Apr. 28, 2015

(30) Foreign Application Priority Data
May 1, 2014 (GB) 1407731.7

(51) Int. Cl. G06Q 20/40

(52) U.S. Cl. CPC G06Q 20/40145

(57) ABSTRACT

Methods, devices and a system for transaction initiation are disclosed. Biometric information is obtained from a user, and the obtained biometric information is compared with a plurality of stored account identifiers, to identify an account having an account identifier corresponding to the obtained biometric information. Access is permitted for the user to the identified transaction account to initiate the transaction. To enable this initiation, biometric user information is obtained and associated with an account identifier for the user, and the account identifier is stored for a user account, for permitting access to the user account to the user on provision of the biometric user information.

### FIELD

The present disclosure is generally directed to methods, devices and systems for initiating transactions for users, and for enabling such transaction initiation.

### BACKGROUND

This section provides background information related to the present disclosure which is not necessarily prior art.

Various types of user interactive transactions, such as financial transactions, are well known. Typically these require the establishment of an account which the user can then later access by some means. There is hence usually a step for finding the correct account for the current user, from a set of accounts held by an institution.

For example, user transaction cards can be used for payment or account transactions at ATMs, or at merchant points of interactions. These may use a magnetic stripe or chip and PIN interactions. The chip or magnetic stripe will usually contain account information (and information on the issuer, processing authority, and the like) identifying the user, so that the proper account can be accessed. Proximity transactions, such as near-field communication (NFC), contactless, or local/wireless transactions are also well known. Mobile telecommunication devices can be used for similar transactions. Here, the account information may be stored on the device.

Other transactions, such as bill payment and collection of pension or benefit payments, may use similar devices, though some still run on a payment book and signature, or other similar older transactional methods. Each will at some point be required to identify the user's account, to enable the transaction to proceed.

Since transactional cards, devices or books can be stolen, spoofed, forged or intercepted in some way, these are not usually considered sufficient to validly identify the current user as the account holder, rather than a fraudulent user. Transactions therefore commonly use in addition, systems of verification or authentication; these attempt to ensure that the holder of a card or other transaction device (or payment book) is the legitimate user. For example, the chip and PIN system requires a user to enter a PIN number or password which is checked against a record on a smart card chip on their transaction card. Transaction cards commonly have a user's signature affixed, which is matched with a user signature at the time of the transaction. Online transactions require passwords and other verification. Mobile devices record user keys or PINs, which must be entered by a user before a transaction can be completed, for example on a mobile banking application.

It may be noted that such (secondary) verification factors, commonly using knowledge authentication factors, such as the memory of a PIN, are not by themselves sufficient for a transaction, as they cannot also give sufficient account information. For example, PIN numbers are typically too short to be able to uniquely identify an account number, sort code, issuer and the like for a user—the card, device or book having the account information is also required.

Such authentication and verification systems can be vulnerable, as it is possible for the password, key or PIN to become known by a third party that is not the authorized user of the financial transaction device or account holder. If this occurs, the third party can fraudulently use the password to undertake a transaction.

Many such security systems can also introduce inconvenience for the user, and hence insecurity into the system; cards, book or devices must be taken to the transaction point and may in the meantime be forgotten, stolen or mislaid. Authentication devices or systems, such as PINs, ID cards or security token generating devices, may be forgotten or mislaid.

The present disclosure aims to address these problems and provide improvements upon the known devices and methods.

### SUMMARY

This section provides a general summary of the disclosure, and is not a comprehensive disclosure of its full scope or all of its features. Aspects and embodiments of the disclosure are also set out in the accompanying claims.

In general terms, one embodiment of a first aspect of the disclosure can provide a method of initiating a transaction for a user, comprising the steps of: obtaining biometric information from the user; comparing the obtained biometric information with a plurality of stored account identifiers, to identify an account having a stored account identifier corresponding to the obtained biometric information; and permitting access for the user to the identified account to initiate the transaction.

This allows a straightforward means of replacing the devices, cards, books (possession factors) of previous methods, as well as the authentication items (knowledge factors such as PINs) with a single feature which can be used to access the account. This method may be more secure than previous methods, because biometric user information cannot be forgotten or mislaid, and is usually difficult to steal or spoof. In addition, this method allows cheaper and more convenient transactions than for previous systems using cards, devices or books for transactions; issuers will not have to provide the physical items, and the user will have nothing additional to carry.

The biometric information obtained from the user may, for example, be captured from the user, for instance by a scanning device.

In one embodiment, comparing the obtained biometric information with a plurality of stored account identifiers may comprise comparing the obtained biometric information with stored biometric information forming the account identifier. For example, an image having biometric information may be matched to an image associated with the account, for example, by mapping to the account number.

The transaction may be a financial transaction, such as a banking transaction or bill paying transaction, and the user account may be a transaction account to match this type of transaction, or may be accessible for different types of transactions.

In another embodiment, comparing the obtained biometric information with a plurality of stored account identifiers may comprise processing the obtained biometric information to generate a transaction account identifier. For example, the comparison step may further comprise comparing the transaction account identifier, generated from the obtained biometric information, to the plurality of stored account identifiers, to determine correspondence between the transaction account identifier and stored account identifiers. For example, the comparison may simply find the (single) correct corresponding stored account identifier. This may be particularly applicable if the stored account identifiers are codes or are numerical, or are accessible by a look-up table or the like.

Suitably, the comparison step comprises determining a correspondence between the transaction account identifier and a given stored account identifier; and identifying the account having the given stored account identifier as the account to which to permit user access. It may be determined that a match to the biometric information is a closest match by a highest similarity or correspondence measure score.

This allows an (instant or immediate) account identifier generated in response to the user biometric information, to be used for comparison or matching to stored account identifiers. Thus in alternative embodiments, rather than the biometric information itself being used for matching to stored biometric information, the matching may be done between account identifiers generated from biometric information. The account identifiers may therefore be much simpler, and therefore the comparison step less computationally expensive than a comparison of biometric information, such as images.

In an embodiment, the biometric information obtained from the user is image information, and processing the obtained biometric information to generate a transaction account identifier comprises generating a point map from the obtained biometric image information. The method may further comprise processing the point map to generate a code for the generated transaction account identifier. The code may for example be a 64-bit integer or number.

Suitably, the stored account identifiers are account identifiers generated from biometric information obtained from respective users. The store may therefore contain a database of account identifiers previously generated from biometric information from users, the respective account identifiers linked to respective users' accounts.

In an embodiment, permitting access for the user to the identified account to initiate the transaction comprises using the obtained biometric information from the user to authenticate access for the user to the identified account. The step of permitting access may comprise comparing the obtained biometric information with stored biometric data associated with the identified account.

The biometric information can therefore also be used (again) for a second stage of authenticating or verifying the user, once the proper account associated with the generated account identifier has been identified.

In an embodiment, obtaining biometric information from the user comprises capturing the biometric information from the user using a capturing device, such as a scanning device. The biometric information may be obtained from a fingerprint of the user.

Suitably, the step of obtaining biometric information from the user comprises obtaining first and second biometric information sets from the user, and the step of comparing comprises comparing the second set of obtained biometric information with a second category of stored account identifiers.

Thus several different biometrics can be used, each for a different user account. For example, different fingerprints may be used for different accounts, for example, so that an account may be associated with each finger on a user's hand.

In an embodiment, the capturing or scanning device is configured to validate a proof-of-life characteristic of a user interaction.

One embodiment of a second aspect of the disclosure can provide a method for enabling initiation of a transaction for a user, comprising the steps of: obtaining biometric user information; associating the obtained biometric user information with an account identifier for the user; and storing the account identifier for a user account, for permitting access to the user account to the user on provision of the biometric user information.

This enables the methods of initiating a transaction described above; the user's biometric information is obtained and linked to the user's account identifier, so that a later provision of the biometric information can provide access to the account.

Each account identifier is typically unique, so that it can uniquely link the user to the user account. In the case where an account identifier (such as a bank account number) already exists, the account identifier with which the biometric user information is associated, or which is generated from the biometric user information, can be mapped to the existing account identifier/number. Where the user is opening an account at the same time as providing the biometric identifying information, the generated account identifier (e.g. a resultant code) can be used as or instead of the usual account number, or coded into an account record including the usual account number/sort code format.

In one embodiment, associating the obtained biometric information with an account identifier comprises storing the obtained biometric user information as the account identifier for the user account.

In another embodiment, associating the obtained biometric information with an account identifier comprises processing the obtained biometric user information to generate the account identifier for the user account.

Suitably, the steps of associating and storing further comprise storing the obtained biometric user information for authenticating access for the user to the user account.

In an embodiment, obtaining biometric user information comprises obtaining first and second biometric user information sets, and the steps of associating and storing comprise: associating the second set of obtained biometric user information with a second category of account identifier for the user, storing the account identifier for a second user account, for permitting access to the second user account to the user on provision of the second set of biometric user information.

One embodiment of a third aspect of the disclosure can provide a device for initiating a transaction for a user, configured to, or comprising one or more processors configured to, implement the method of any of the above described embodiments.

One embodiment of a fourth aspect of the disclosure can provide a system for initiating a transaction for a user, the system comprising: a scanner for obtaining biometric information from the user; a store for storing a plurality of account identifiers; and a processor for: comparing the obtained biometric information with the plurality of stored account identifiers, to identify an account having a stored account identifier corresponding to the obtained biometric information; and permitting access for the user to the identified account to initiate the transaction.

One embodiment of a fifth aspect of the disclosure can provide a method of initiating a transaction for a user, comprising using a scanner to obtain biometric information from the user; by a processor: accessing a store storing a plurality of account identifiers; comparing the obtained biometric information with the plurality of stored account identifiers, to identify an account having a stored account identifier corresponding to the obtained biometric information; and using a locking device to transition a transactional device from an access-denied state to an access-permitted state, to permit access for the user to the identified account to initiate the transaction.

Further aspects of the disclosure comprise computer programs (or a media device storing such a program) which, when loaded into or run on a computer, cause the computer to become a device or system, or to carry out a method, according to the aspects and embodiments described above.

The above aspects and embodiments may be combined to provide further aspects and embodiments of the disclosure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The disclosure will now be described by way of example with reference to the accompanying drawings, in which:

FIG. 1 is a diagram illustrating steps of a method for initiating a transaction, according to an embodiment of the disclosure; and

FIG. 2 is a diagram illustrating a system for initiating and/or enabling a transaction, for example by generating an account identifier, according to an embodiment of the disclosure.

### DETAILED DESCRIPTION

Embodiments of the present disclosure provide transaction systems in which a biometric replaces the usual physical transaction items carried by a user, such as cards, tokens, payment books or the like, and can also replace authentication systems such as PINs, passwords and the like.

Traditional verification or authentication items or factors, such as transaction cards (a possession factor) used with PINs (a knowledge factor), or account books with passwords, arise because neither factor can do the job by itself. Transaction cards can identify a unique user account, but are too easily stolen so must be authenticated. PINs and passwords can authenticate account access, but usually cannot uniquely identify an account. PIN numbers, for example, are not sufficiently long for there to be sufficient combinations available for the number of users, and if there were they would be too long to be memorable. Passwords are notorious for being duplicated amongst users.

The present disclosure's use of biometrics can do both. The biometric can be used both as the account identifier, and if needed, as an additional authentication factor.

Embodiments of the disclosure also provide the use of different biometrics from the same user, so that different accounts can be accessed, thereby reducing further the need for (additional) physical transaction items. As an example, if fingerprints are used, ten different accounts can be accessed by two hands, thereby replacing a large number of physical transaction items. These methods are therefore cheaper and more environmentally friendly than previous methods, as there is no need for the production of large numbers of physical items, and the communication of these to users.

Since no physical transaction items need to be posted to users, these cannot be intercepted, a further advantage of the present embodiments. Additionally, new programmes from issuers can potentially be rolled out to market with greater speed, since there is no need to replace physical transaction items. These methods may also cater better for users with physical or sensory impairments, as it will be possible for the biometric to be obtained by the system without significant physical input from the user, or physical manipulation of a transaction card or the like.

Biometric characteristics of a user cannot usually be lost or stolen, and are much more difficult to spoof or replicate than simple measures such as PINs and passwords.

Biometric information has previously been used as a secondary authentication step alone, such as in fingerprint corroboration of a transaction card system. Such systems have not attempted to use the biometric as the account identifier. Biometrics have also been used in systems such as passport control replacement, in which accounts and transactions are not required, and there has therefore been no need to use the biometric as an account identifier as opposed to merely a corroborative feature. Previously considered uses have not considered the possibility of using the biometric itself as the account identifier in a transaction environment.

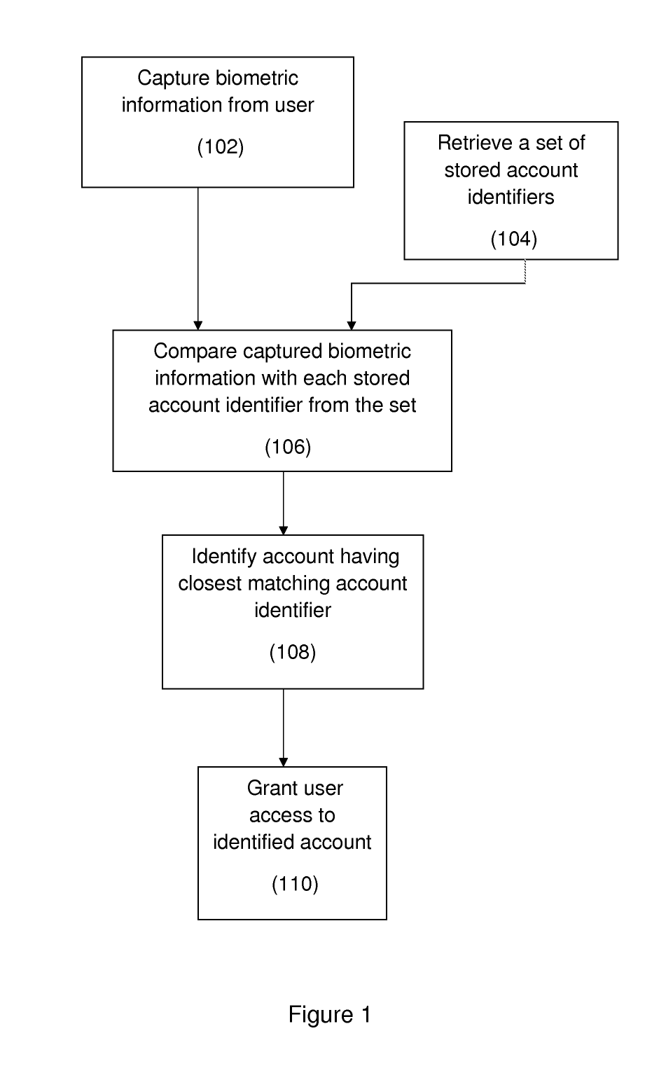

FIG. 1 is a diagram illustrating steps of a method for initiating a transaction, according to an embodiment of the disclosure. First, biometric information is captured (102) from the user (or loaded into a processing environment, having been previously captured from the user). The biometric information gathered may be any of the following types, or any further types of biometric information sufficient to distinguish any given user from another on the basis of that biometric alone: finger or hand/palm print; retina or iris recognition; face recognition; hand geometry or other such body part recognition; DNA; or odour/scent.

The capture may be done by a capture device, such as an image capture device, scanner, or sensor plate. Examples of devices capturing the above types of biometric information have been previously considered. For certain of the biometric information types noted above, DNA sampling or olfactory sensing or the like may be required.

In an embodiment of the disclosure, the biometric used is a fingerprint. The capture device can be a sensor detecting the ridges making up the arches, loops and whorls of the fingerprint. The sensor can be any of the previously considered types, such as a sensor plate or a 3D imaging device into which a finger is inserted.

A set of stored account identifiers is then retrieved (104). These may, for example, be a collected database of all account identifiers for all account holders managed by an issuer. The account identifiers may be stored locally on the system (such as an ATM) being used, or downloaded on-the-fly over a network from a server.

The account identifiers are unique factors identifying the account for the respective user. An example of an identifier would be an account number and sort code. In embodiments of the disclosure, where account details already exist for a user, an account identifier can be mapped to those details.

The account identifier may be some other unique feature which can be associated with the user account, so long as it is sufficient to uniquely identify that user account. In embodiments of the disclosure, biometric information from the user is employed as an account identifier. In an initial establishment stage, the user is requested to provide the biometric information, and this is used to provide a stored feature uniquely identifying that user. Later, the user can provide biometric information in the manner described presently with reference to FIG. 1, and this can be compared to the stored identifier generated from the user's same own biometric information, to identify that user as the unique account holder.

In one embodiment, the biometric information itself is used as the identifier—for example, a fingerprint ridge image may be associated with the account, so that any user providing this fingerprint can be immediately linked uniquely with that account, and provided access to it. In another embodiment, the biometric is processed to generate a more concise information set to be associated uniquely with the user account. For example, a fingerprint image may be analysed to produce a point map of the patterns in the ridges making up the arch, loop and whorl structure of the fingerprint. This point map (if sufficiently detailed and accurately reflecting the fingerprint) is unique to the user, so can be stored as the unique account holder identifier.

In a further embodiment, the information set may be further processed to produce a code or number, such as a 64-bit integer, which can be used as the account identifier. For example, an algorithm can produce a 64-bit integer from a point map, derived from a fingerprint image. Such a code has the advantage that a search of the database can likely be made far more quickly than for a point map or image or the like, and that a match can be more readily determined. If the codes are identical, it may be assumed that the correct unique match has been found. For images or point maps, it may be that a similarity score may have to meet a threshold, rather than an entirely identical match being found.

Once the set of stored account identifiers has been retrieved, the biometric information from the user can be compared (106) with this set. Essentially a search is performed using the captured biometric information. In embodiments using biometrics as the stored identifiers, this will be a search for a closest match among the stored biometrics, identifying a closest match as the user's account (identifier).

In embodiments using an account identifier generated from the user's captured biometric (a transaction account identifier, i.e. one that has been generated to perform the transaction and match with a stored account identifier), the search will try and find a match for the generated identifier. This method assumes that the user's stored identifier, generated from the user's biometric on setting up this functionality, will be highly similar if not identical to an identifier generated from the same user biometric during a transaction. In practice, it may be that matches will be somewhat more challenging, for example, if the user's finger moves on the scanner or is distorted. However, the biometric (particularly in the case of fingerprints) should be sufficiently unique for the similarity between even a distorted image or identifier from the biometric, and the original stored image or identifier, to be far greater than any similarity between biometrics (distorted or not) of other users.

A typical correspondence or similarity measure in such an embodiment will compare the identifiers (images, point maps, codes or the like), for example, using previously considered techniques for image comparison or mapping, and assign a similarity score. The score should be over a threshold to establish a match. If the user biometric input is so distorted that no match can be found, the user can be requested to re-capture the information (e.g. to re-scan the fingerprint).

Once a (closest) match is found, the account associated with the matching identifier can be identified as the user's account (108), i.e. that account matching the user's input biometric. Access to the account can then be granted to the user (110).

These processes can be performed using additional biometrics from the same user, to link the user to other accounts owned by the user. For example, a user might use a retinal scan to access a private banking transactional system, and a fingerprint scan to access an ATM transaction. A user could establish links with several different accounts using different fingers, so that various accounts may be accessed at the same kiosk or terminal simply by changing the finger offered for scanning.

The user's captured biometric information may also be used in addition to the account identifying methods above, in an additional authentication step. For example, if an account identifier (such as a code or point map) has been searched and closest match identified from the store, for greater confidence in the result the system may use the currently scanned biometric from the user and compare it with an biometric stored with the account identifier. For example, if an account identifier code has found a matching code in the database, the database entry for that account user could also include the full biometric image for the user. The biometric image scanned during the transaction can then be compared with the stored version to make sure the correct account is identified, and that the registered user is indeed present.

This second stage comparison may be different from the comparison to identify the proper account; for example, as the comparison is now being made one-to-one (there is only one matching biometric image associated with the account) rather than one-to-many (searching for a match to a generated transaction account identifier in a database of many stored account identifiers), this second step can be allowed to take longer and/or use more computational resources, for example, comparing two full images rather than codes or point maps.

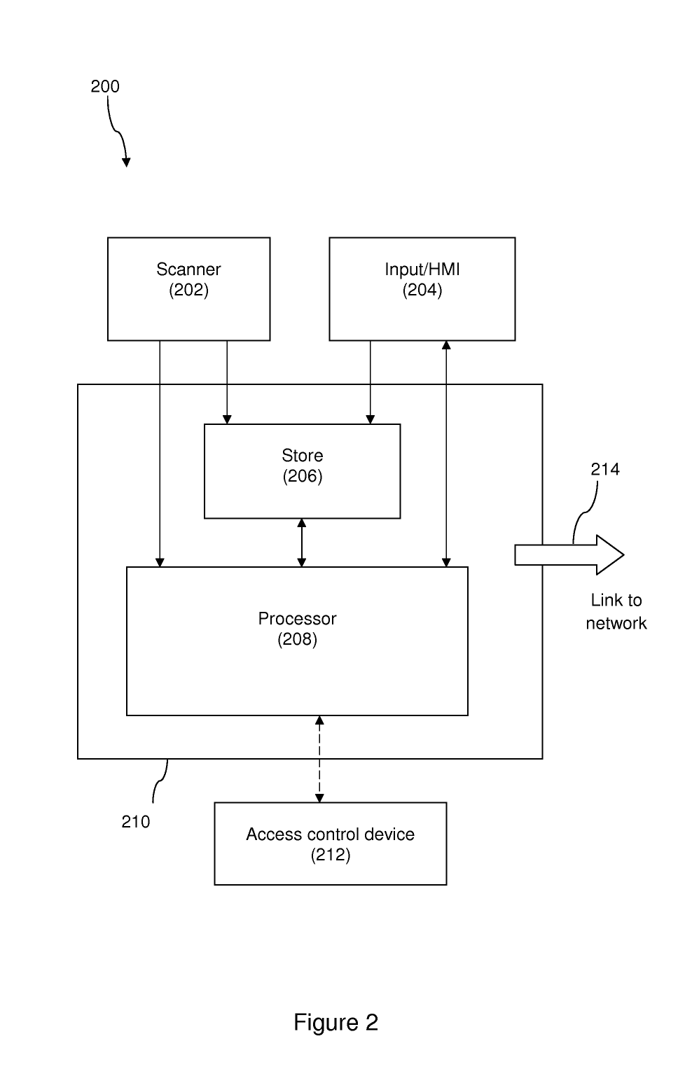

FIG. 2 illustrates a system (200) for initiating and/or enabling the initiation of a transaction according to an embodiment of the disclosure. The system may be embodied in, for example, an ATM machine, or in a terminal kiosk providing bill payment or benefit account access.

The system employs a scanner (202) to obtain the biometric information from the user. The system also includes an input or human-machine interface (HMI) device (204), with which the user can interact. For example, on an ATM this may take the form of a touch-screen. The system (200) includes a store (206), which may be some form of digital storage such as a solid state memory, and a processor (208). The store and the processor in this embodiment are contained in a computer or logic sub-system (210). The computer sub-system (210), the store (206) and the processor (208) may each have access to an external link (214) to a network.

Where the user is providing biometric information for generating an account identifier, the HMI (204) may be used to establish the identity and account details of the user, for example, by scanning a transaction card or an identification item, such as an ID card, or by requesting answers to security questions of the user. Once the system has identified the user and the relevant account, the biometric information is stored (206) and may be sent to the processor (208) for generating the account identifier. This account identifier can then be added back to the store (206), and sent over the network link (214) to other terminals, and to a central database storing all user account identifier for provisioning to terminals. The biometric information may also be stored to allow a second authentication step in a later transaction for the user.

In an alternative, where the identification item is a biometric ID, such as a biometric passport, the biometric information can instead be read directly from the ID, along with any other identity or account details required to verify the user.

The process can be repeated for different items of biometric information (such as different fingerprints), and the respective biometric information stored and/or transmitted to the network for the respective accounts.

Where the user is attempting to access an account, the scanned biometric information can be stored, but is typically sent to the processor for the comparison stage. Here, records of account identifiers stored in the store (206) are retrieved, and compared by the processor (208) to the user's scanned biometric information. For example, where the biometric information itself has been stored as the account identifier, the processor may compare the scanned biometric information with each account identifier biometric information set. In another embodiment, the processor generates an account identifier from the scanned biometric, and this identifier can then be searched from the store of account identifiers. Once a (closest) match is found, the processor instructs an access control device to allow the user access to the account, via the HMI. In this embodiment, the access control device (212) is physically separate from the computer sub-system (210), and is instructed by the processor (208).

The scanner (202) may be provided with a detector for establishing a “proof-of-life” characteristic, to avoid replication or spoofing of the biometric information. For example, the detector may seek to avoid allowing access to a fingerprint lifted from a site of user fingerprint contact. This may be done by employing a pulse detection sensor in the scanner, in addition to the fingerprint scanning sensor.

The system (200) shown in FIG. 2 may have elements in common with other systems using computer-implemented instructions. The processor (206) may implement such steps as set out in the methods described above. In embodiments, executable instructions for such steps are stored in the store or memory (206). Store (206) can be any device allowing information such as executable instructions and/or written works to be stored and retrieved, and may include one or more computer readable media.

The HMI (204) is operatively coupled to the processor (208), and may include an output device such as a display device, a liquid crystal display (LCD), organic light emitting diode (OLED) display, or “electronic ink” display, or an audio output device, a speaker or headphones. The user interface of the HMI may include, among other possibilities, a web browser and client application.

In some embodiments, the HMI (204) includes an input device (not shown) for receiving input from the user, such as option choices, or password or PIN numbers. The input device may include, for example, a keyboard, a pointing device, a mouse, a stylus, a touch sensitive panel, a touch pad, a touch screen, a gyroscope, an accelerometer, a position detector, or an audio input device. The system (200) may include a communication interface (not shown) in order to permit transmission via the network link (214). The interface may, for example, be communicatively couplable to a remote device such as a server system of a transaction operator or issuer. The communication interface may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

It will be appreciated by those skilled in the art that the present disclosure has been described by way of example only, and that a variety of alternative approaches may be adopted without departing from the scope of the disclosure, as defined by the appended claims.

It should also be appreciated that the disclosure is not limited to the embodiment(s) described herein but can be amended or modified without departing from the scope of the present disclosure. Additionally, it will be appreciated that in embodiments of the disclosure some of the above-described steps may be omitted and/or performed in an order other than that described.

In addition, it should be appreciated that the functions and/or steps described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should further be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of initiating a transaction for a user, comprising:
obtaining biometric information from the user;
comparing the obtained biometric information with a plurality of stored account identifiers, to identify an account having a stored account identifier corresponding to the obtained biometric information; and
permitting access for the user to the identified account to initiate the transaction.

2. The method according to claim 1, wherein comparing the obtained biometric information comprises processing the obtained biometric information to generate a transaction account identifier.

3. The method according to claim 2, wherein comparing the obtained biometric information further comprises comparing the transaction account identifier, generated from the obtained biometric information, to the plurality of stored account identifiers, to determine correspondence between the transaction account identifier and stored account identifiers.

4. The method according to claim 2, wherein comparing the obtained biometric information comprises:
determining a correspondence between the transaction account identifier and a given stored account identifier; and
identifying the account having the given stored account identifier as the account to which to permit user access.

5. The method according to claim 2, wherein the biometric information obtained from the user is image information, and wherein processing to generate the transaction account identifier comprises generating a point map from the obtained biometric image information.

6. The method according to claim 5, further comprising processing the point map to generate a code for the generated transaction account identifier.

7. The method according to claim 1, wherein the stored account identifiers are account identifiers generated from biometric information obtained from respective users.

8. The method according to claim 1, wherein permitting access comprises using the obtained biometric information from the user to authenticate access for the user to the identified account.

9. The method according to claim 8, wherein permitting access comprises comparing the obtained biometric information with stored biometric data associated with the identified account.

10. The method according to claim 1, wherein obtaining biometric information comprises capturing the biometric information from the user using a capturing device.

11. The method according to claim 10, wherein the capturing device is configured to validate a proof-of-life characteristic of a user interaction.

12. The method according to claim 1, wherein the biometric information is obtained from one of: a finger or hand/palm print; a retina or iris; the face; a hand geometry; DNA; a scent of the user.

13. The method according to claim 1, wherein obtaining biometric information comprises obtaining first and second biometric information sets from the user, and wherein comparing the obtained biometric information comprises comparing the second set of obtained biometric information with a second category of stored account identifiers.

14. A method for enabling initiation of a transaction for a user, comprising:
obtaining biometric user information;
associating the obtained biometric user information with an account identifier for the user; and
storing the account identifier for a user account, for permitting access to the user account to the user on provision of the biometric user information.

15. The method according to claim 14, wherein associating the obtained biometric user information comprises storing the obtained biometric user information as the account identifier for the user account.

16. The method according to claim 14, wherein associating the obtained biometric user information comprises processing the obtained biometric user information to generate the account identifier for the user account.

17. The method according to claim 14, further comprising storing the obtained biometric user information for authenticating access for the user to the user account.

18. The method according to claim 14, wherein obtaining biometric user information comprises obtaining first and second biometric user information sets, and wherein associating the obtained biometric user information and storing the account identifier comprise, respectively:
associating the second set of obtained biometric user information with a second category of account identifier for the user; and
storing the account identifier for a second user account, for permitting access to the second user account to the user on provision of the second set of biometric user information.

19. (canceled)

20. (canceled)

21. A system for initiating a transaction for a user, the system comprising:
a scanner for obtaining biometric information from the user;
a store for storing a plurality of account identifiers; and
a processor for:
comparing the obtained biometric information with the plurality of stored account identifiers, to identify an account having stored account identifier corresponding to the obtained biometric information; and
permitting access for the user to the identified account to initiate the transaction.

22. (canceled)
